(19) United States
(12) Patent Application Publication
(10) Pub. No.: US 2025/0125111 A1
(43) Pub. Date: Apr. 17, 2025

(54) PROTECTIVE ELEMENT

(71) Applicant: DEXERIALS CORPORATION, Tochigi (JP)

(72) Inventor: Yoshihiro Yoneda, Shimotsuke-shi (JP)

(21) Appl. No.: 18/688,698

(22) PCT Filed: Aug. 26, 2022
(86) PCT No.: PCT/JP2022/032145

§ 371 Date: Mar. 1, 2024

(30) Foreign Application Priority Data
Sep. 7, 2021 (JP) 2021-145576

(51) Int. Cl. H01H 85/175; H01H 85/055; H01H 85/143

(52) U.S. Cl. CPC H01H 85/175; H01H 85/055; H01H 85/143

(57) ABSTRACT

A protective element having a fuse element laminated body, an insulating case housing the fuse element laminated body, a first terminal, and a second terminal, wherein the fuse element laminated body includes a plurality of fusible conductor sheets arranged in parallel in a thickness direction and a first insulating member disposed between each of the plurality of fusible conductor sheets, either in proximity to, or in contact with, the fusible conductor sheets; each of the plurality of fusible conductor sheets has a mutually opposing first end section and second end section; one end of the first terminal is connected to the first end section while the other end of the first terminal is exposed outside the insulating case; and one end of the second terminal is connected to the second end section while the other end of the second terminal is exposed outside the insulating case.

### TECHNICAL FIELD

The present invention relates to a protective element.

Priority is claimed on Japanese Patent Application No. 2021-145576, filed Sep. 7, 2021, the content of which is incorporated herein by reference.

### BACKGROUND ART

Conventional fuse elements are elements which are heated and melt, when an electric current exceeding the rated value flows through the current path, thereby breaking the current path. Protective elements (fuse elements) fitted with a fuse element are used in a wide variety of fields, from household electrical appliances to electric vehicles and the like.

For example, Patent Document 1 discloses a fuse element for use mainly in electrical circuits for vehicles and the like, the fuse element including two elements connected between terminal sections located at the two end portions, and a fusion portion provided in approximately the central portion between the elements. Patent Document 1 also discloses a fuse in which a pair of fuse elements is stored inside a casing, and an arc-extinguishing material is injected into and enclosed in the space between the fuse elements and the casing.

### CITATION LIST

### Patent Document

Patent Document 1: Japanese Unexamined Patent Application, First Publication No. 2017-004634

### SUMMARY OF INVENTION

### Technical Problem

In protective elements installed in high-voltage and large-current electric current paths, arc discharge tends to occur more frequently when the fuse element melts. If a large arc discharge occurs, then the insulating case in which the fuse element is housed sometimes be destroyed. Accordingly, the occurrence of arc discharge is suppressed by using metals such as copper with a low resistance and a high melting point as the material for the fuse element. Further, other countermeasures that are employed include using a durable material with superior heat resistance such as a ceramic as the material for the insulating case, and increasing the size of the insulating case.

The present invention has been developed in light of the above circumstances, and has an object of providing a protective element that is less likely to suffer large arc discharges when the fuse element melts, and enables the size and weight of the insulating case to be reduced.

### Solution to Problem

In order to achieve the above object, the present invention provides the following aspects.
[1] A protective element having a fuse element laminated body, an insulating case housing the fuse element laminated body, a first terminal, and a second terminal, wherein the fuse element laminated body includes a plurality of fusible conductor sheets arranged in parallel in a thickness direction and a first insulating member disposed between each of the plurality of fusible conductor sheets, either in proximity to, or in contact with, the fusible conductor sheets; each of the plurality of fusible conductor sheets has a mutually opposing first end section and second end section; one end of the first terminal is connected to the first end section while the other end of the first terminal is exposed outside the insulating case; and one end of the second terminal is connected to the second end section while the other end of the second terminal is exposed outside the insulating case.
[2] The protective element according to [1], wherein a second insulating member is disposed between the lowermost located fusible conductor sheet among the plurality of fusible conductor sheets and the insulating case, and between the uppermost located fusible conductor sheet among the plurality of fusible conductor sheets and the insulating case.
[3] The protective element according to [2], wherein the first insulating member and the second insulating member are partitioned in a central section between the first end section and the second end section of the fusible conductor sheets so as to cut the first insulating member and the second insulating member along a direction from the first end section toward the second end section.
[4] The protective element according to [2] or [3], further having a pressing member which is disposed inside the insulating case and applies pressure to the second insulating member in a direction of a side of the fusible conductor sheets.
[5] The protective element according to any one of [2] to [4], wherein at least one of the first insulating member, the second insulating member and the insulating case is formed from a material having a tracking resistance index CTI of 500 V or higher.
[6] The protective element according to any one of [2] to [5], wherein at least one of the first insulating member, the second insulating member and the insulating case is formed from a resin material selected from the group consisting of polyamide-based resins and fluorine-based resins.
[7] The protective element according to any one of [1] to [6], wherein each of the plurality of fusible conductor sheets is a laminate having a low-melting point metal layer and a high-melting point metal layer, the low-melting point metal layer contains tin, and the high-melting point metal layer contains silver or copper.
[8] The protective element according to [7], wherein each of the plurality of fusible conductor sheets is a laminate having two or more of the high-melting point metal layer and one or more of the low-melting point metal layer, and each low-melting point metal layer is disposed between two high-melting point metal layers.
[9] The protective element according to any one of [1] to [6], wherein each of the plurality of fusible conductor sheets is a single-layer body containing silver or copper.
[10] The protective element according to any one of [1] to [9], wherein each of the plurality of fusible conductor sheets has a fusion portion between the first end section and the second end section, and the cross-sectional area of the fusion portion across a direction of current flow from the first end section toward the second end section is smaller than the cross-sectional area of the first end section and the second end section across the direction of current flow.

### Advantageous Effects of Invention

The present invention is able to provide a protective element that is less likely to suffer large arc discharges when the fuse element melts, and enables the size and weight of the insulating case to be reduced.

### BRIEF DESCRIPTION OF THE DRAWINGS

FIG. 1 is a perspective view of a protective element according to one embodiment of the present invention.

FIG. 2 is an exploded perspective view of the protective element illustrated in FIG. 1.

FIG. 3 is an exploded perspective view of the fuse element laminated body illustrated in FIG. 2.

FIG. 4 is a plan view of the fusible conductor sheets illustrated in FIG. 3.

FIG. 5 is a cross-sectional view of the protective element along the line V-V′ shown in FIG. 1.

FIG. 6 is a longitudinal sectional view of the protective element along the line VI-VI′ shown in FIG. 1.

FIG. 7 is a longitudinal sectional view illustrating the fuse element laminated body of the protective element illustrated in FIG. 1 in a fused state.

### Description of Embodiments

Embodiments of the present invention are described below in detail with appropriate reference to the drawings. The drawings used in the following description may sometimes be drawn with specific portions enlarged as appropriate to facilitate comprehension of the features of the present invention, and the dimensional ratios and the like between the constituent elements may differ from the actual values. The materials and dimensions and the like presented in the following description are merely examples, which in no way limit the present invention, and may be altered as appropriate within the scope of the present invention.

### Protective Element

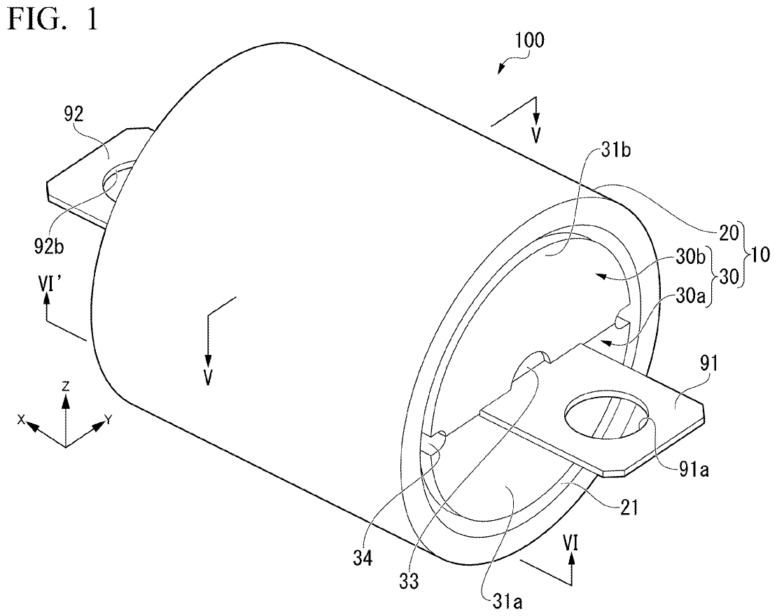

FIG. 1 to FIG. 6 are schematic drawings illustrating a protective element according to one embodiment of the present invention. In the drawings used in the following description, the direction indicated by X represents the direction of current flow through the fuse element. The direction indicated by Y represents a direction orthogonal to the X direction, and is also called the width direction. The direction indicated by Z represents the direction orthogonal to both the X direction and the Y direction, and is also called the thickness direction.

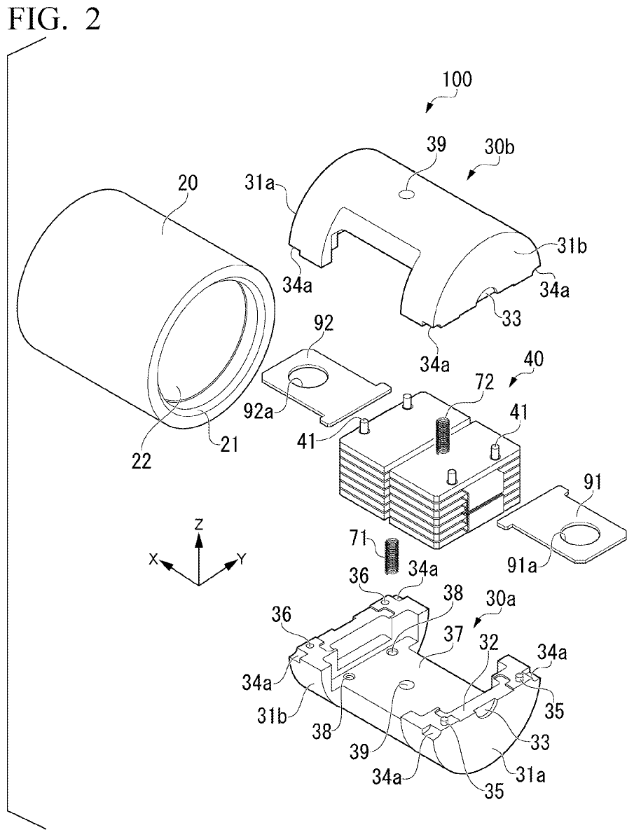

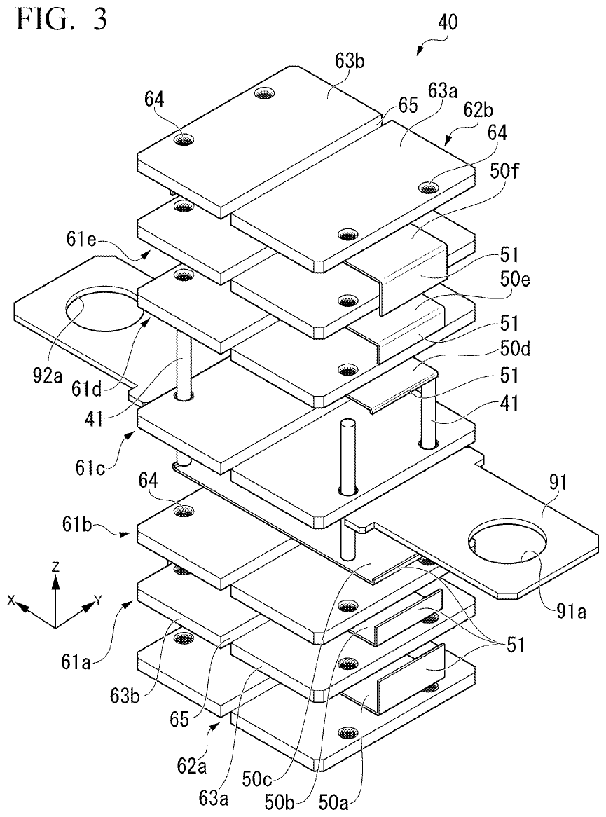

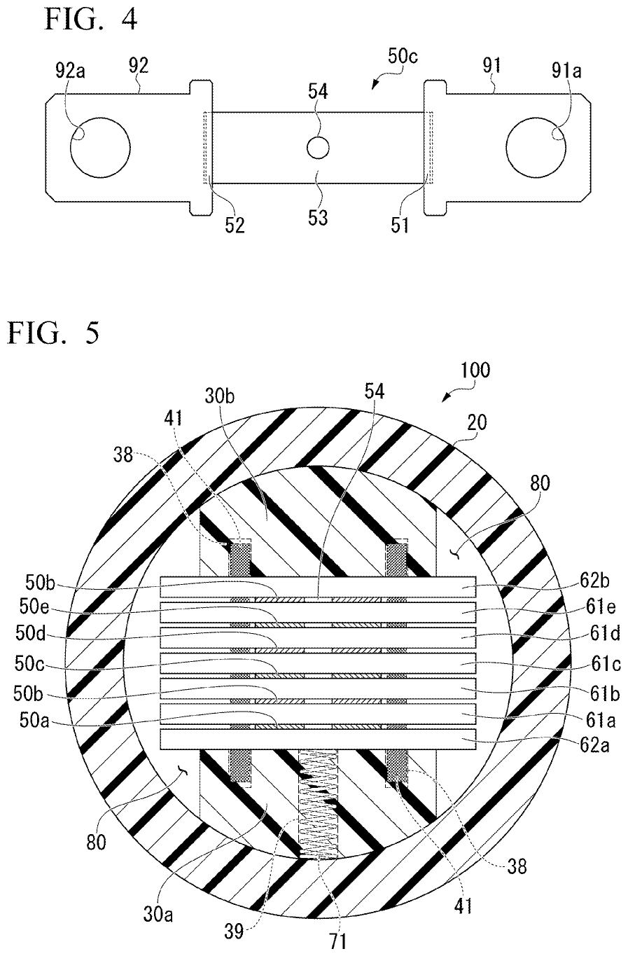

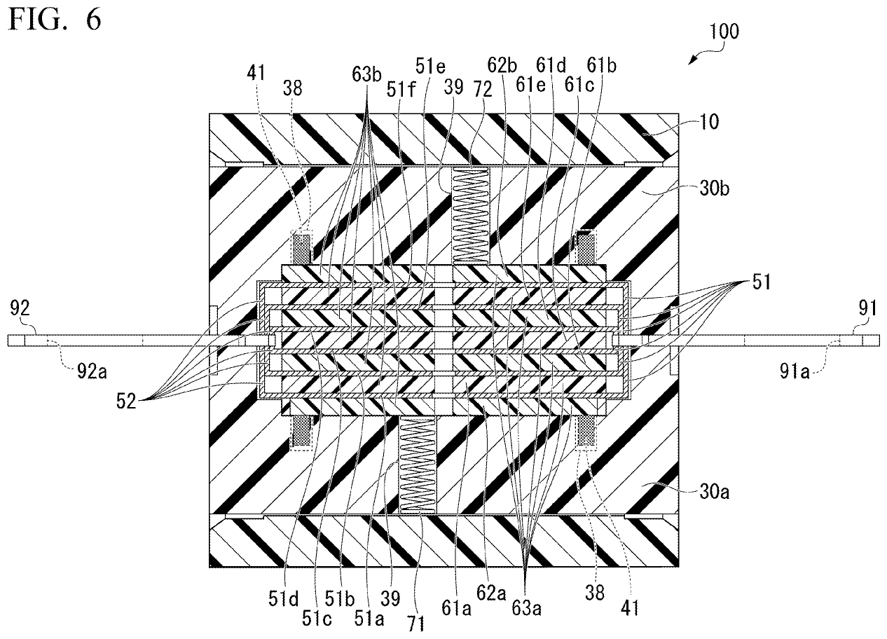

FIG. 1 is a perspective view of a protective element according to one embodiment of the present invention. FIG. 2 is an exploded perspective view of the protective element illustrated in FIG. 1. FIG. 3 is an exploded perspective view of the fuse element laminated body illustrated in FIG. 2. FIG. 4 is a plan view of the fusible conductor sheets illustrated in FIG. 3. FIG. 5 is a cross-sectional view of the protective element along the line V-V′ shown in FIG. 1. FIG. 6 is a longitudinal sectional view of the protective element along the line VI-VI' shown in FIG. 1.

The protective element 100 of this embodiment illustrated in FIG. 1 to FIG. 6 has an insulating case 10, a fuse element laminated body 40 housed inside the insulating case 10, a first pressing member 71, a second pressing member 72, a first terminal 91, and a second terminal 92. In the protective element 100 of this embodiment, the current flow direction is the direction along which electricity flows during use (namely, the X direction), and the cross-sectional area of the current flow direction is the area of a plane (Y-Z plane) in a direction orthogonal to the current flow direction.

### Insulating Case

The insulating case 10 is a substantially circular cylinder. The insulating case 10 is composed of a cover 20 and a holding member 30.

The cover 20 is a circular cylindrical shape that is open at both ends. The inside edge of each opening of the cover 20 is a chamfered inclined surface 21. The central portion of the cover 20 functions as a housing section 22 inside which the holding member 30 is housed.

The holding member 30 is composed of a first holding member 30a and a second holding member 30b. The first holding member 30a and the second holding member 30b have the same shape, and are substantially semicircular cylinders. A terminal mounting surface 32 is provided on the top surface of the each of two end sections (a first end section 31a and a second end section 31b) in the current flow direction of the first holding member 30a and the second holding member 30b (X direction), and a semicircular terminal adhesive injection port 33 is provided in connection with the terminal mounting surface 32. Further, slots 34a are formed in the first end section 31a and the second end section 31b at both edges in the width direction (Y direction). When the first holding member 30a and the second holding member 30b are joined together, the slots 34a form hollow case adhesive injection ports 34 having semicircular channel shapes when viewed in cross-section from the current flow direction. Moreover, protrusions 35 are provided on the top surface of the first end section 31a, and recesses 36 are provided in the top surface of the second end section 31b. The holding member 30 is formed by engaging the protrusions 35 of the first holding member 30a with the recesses 36 of the second holding member 30b, and engaging the recesses 36 of the first holding member 30a with the protrusions 35 of the second holding member 30b.

The central region in the current flow direction of the first holding member 30a and the second holding member 30b functions as a fuse element housing section 37. The fuse element housing section 37 includes guide pin insertion holes 38 that mate with guide pins 41 to secure the fuse element laminated body 40, and a pressing member insertion hole 39 that supports a pressing member (the first pressing member 71 or the second pressing member 72) that applies pressure to the fuse element laminated body 40.

The side surfaces of the fuse element housing section 37 are shaved off, thereby forming an internal pressure buffering space 80 inside the insulating case 10. The internal pressure buffering space 80 has the action of suppressing any sudden increase in internal pressure inside the protective element 100 caused by the gas generated by the arc discharge that can occur when the fuse element laminated body 40 melts.

The cover 20 and the holding member 30 are preferably formed from a material having a tracking resistance index CTI (resistance to tracking (carbonization conduction path) breakdown) of 500 V or higher. The tracking resistance index CTI can be determined using a test based on IEC 60112.

A resin material may be used for the material for the cover 20 and the holding member 30. Resin materials have a smaller heat capacity and a lower melting point than ceramic materials. Accordingly, if the resin material is used as the material for the holding member 30, then when gasified metal and scattered molten metal particles adhere to the holding member 30, the surfaces of the holding member 30 tend to deform, with the metal particles accumulating in granular form at the surfaces of the holding member 30, thereby making it less likely for the adhered metal and metal particles to scatter and form a conduction path.

A polyamide-based resin or a fluorine-based resin, for example, may be used as the resin material. The polyamide-based resin may be an aliphatic polyamide or a semi-aromatic polyamide. Examples of aliphatic polyamides include nylon 4, nylon 6, nylon 46 and nylon 66. Examples of semi-aromatic polyamides include nylon 6T, nylon 9T and polyphthalamide (PPA) resins. Examples of the fluorine-based resin include polytetrafluoroethylene. Further, polyamide-based resins and fluorine-based resins exhibit superior heat resistance and resistance to combustion. In particular, even if an aliphatic polyamide is combusted, graphite is unlikely to be produced. Accordingly, by forming the cover 20 and the holding member 30 using an aliphatic polyamide, the formation of new current pathways as a result of graphite produced by arc discharge upon melting of the fuse element laminated body 40 can be more reliably prevented.

### Fuse Element Laminated Body

The fuse element laminated body 40 has six fusible conductor sheets 50a, 50b, 50c, 50d, 50e and 50f arranged in parallel through the thickness direction (Z direction). First insulating members 61a, 61b, 61c, 61d and 61e are disposed between each pair of the fusible conductor sheets 50a to 50f. The first insulating members 61a to 61e are disposed either in proximity to, or in contact with, the respective fusible conductor sheets 50a to 50f. A state of proximity indicates that the distance between the first insulating members 61a to 61e and the respective fusible conductor sheets 50a to 50f is preferably 0.5 mm or less, and more preferably 0.2 mm or less. Furthermore, a second insulating member 62a is disposed between the lowermost located fusible conductor sheet 50a among the fusible conductor sheets 50a to 50f and the first holding member 30a, either in proximity to, or in contact with, the fusible conductor sheet 50a. Moreover, a second insulating member 62b is disposed between the uppermost located fusible conductor sheet 50f among the fusible conductor sheets 50a to 50f and the second holding member 30b, either in proximity to, or in contact with, the fusible conductor sheet 50f. The width (length in the Y direction) of the fusible conductor sheets 50a to 50f is narrower than the widths of the first insulating members 61a to 61e and the second insulating members 62a and 62b. By disposing the first insulating members 61a to 61e and the second insulating members 62a and 62b either in proximity to, or in contact with, the respective fusible conductor sheets 50a to 50f, the actual space in which arc discharge can occur upon the melting of the fusible conductor sheets 50a to 50f that accompanies overcurrent can be reduced to an extremely narrow space. The plasma that constitutes an arc discharge develops as a result of ionization of the gas within the space, and therefore by reducing the actual space in which arc discharge can occur to an extremely narrow space, the volume of plasma produced can be reduced, and the scale of the arc discharge can be suppressed.

Each of the fusible conductor sheets 50a to 50f has a mutually opposing first end section 51 and second end section 52. The first end sections 51 of the three lowermost fusible conductor sheets 50a to 50c among the fusible conductor sheets 50a to 50f arranged in parallel through the thickness direction are connected to the lower surface of the first terminal 91, and the first end sections 51 of the three uppermost fusible conductor sheets 50d to 50f are connected to the upper surface of the first terminal 91. Further, the second end sections 52 of the three lowermost fusible conductor sheets 50a to 50c among the fusible conductor sheets 50a to 50f are connected to the lower surface of the second terminal 92, and the second end sections 52 of the three uppermost fusible conductor sheets 50d to 50f are connected to the upper surface of the second terminal 92. The positions of connection between the fusible conductor sheets 50a to 50f and the first terminal 91 and second terminal 92 are not limited to the configuration described above. For example, all of the first end sections 51 of the fusible conductor sheets 50a to 50f may be connected to the upper surface of the first terminal 91, or may be connected to the lower surface of the first terminal 91. Similarly, all of the second end sections 52 of the fusible conductor sheets 50a to 50f may be connected to the upper surface of the second terminal 92, or may be connected to the lower surface of the second terminal 92.

Each of the fusible conductor sheets 50a to 50f may be a laminate containing a high-melting point metal layer and a low-melting point metal layer, or may be a single-layer body.

The low-melting point metal layer of the laminate contains Sn. The low-melting point metal layer may be composed solely of Sn, or may be a Sn alloy. Sn alloys are alloys containing Sn as the main component. The Sn alloy is an alloy in which the Sn content is the largest of all the metals contained in the alloy. Examples of Sn alloys include Sn—Bi alloys, In—Sn alloys, and Sn—Ag—Cu alloys. The high-melting point metal layer contains either Ag or Cu. The high-melting point metal layer may be composed solely of Ag, composed solely of Cu, or may be a Ag alloy or a Cu alloy. The Ag alloy is an alloy in which the Ag content is the largest of all the metals contained in the alloy, and the Cu alloy is an alloy in which the Cu content is the largest of all the metals contained in the alloy. The laminate may be a two-layer structure composed of low-melting point metal layer/high-melting point metal layer, or may be a multilayer structure of three or more layers having two or more high-melting point metal layers and one or more low-melting point metal layers, with each low-melting point metal layer disposed between a pair of high-melting point metal layers.

In the case of a single-layer body, the body contains either Ag or Cu. The single-layer body may be composed solely of Ag, composed solely of Cu, or may be an Ag alloy or a Cu alloy.

Each of the fusible conductor sheets 50a to 50f may have a through hole 54 in a central section 53 between the first end section 51 and the second end section 52. By including the through hole 54, the cross-sectional area of the central section 53 can be made smaller than the cross-sectional area of the first end section 51 and the second end section 52. By reducing the cross-sectional area of the central section 53, when a large current exceeding the rating of each fusible conductor sheet 50a to 50f flows through the sheet, the amount of heat generated in the central section 53 increases, and therefore the central section 53 is more likely to function as a fusion site, undergoing melting (and destruction).

In each of the fusible conductor sheets 50a to 50f, the cross-sectional area through the X direction (the current flow direction) is preferably substantially equal. The cross-sectional areas of the fusible conductor sheets 50a to 50f may be within a range of ±10% of the average value across the cross-sectional areas of all of the fusible conductor sheets 50a to 50f. Although there are no particular limitations on the thickness of the fusible conductor sheets 50a to 50f, the thickness may be, for example, within a range from at least 0.01 mm to not more than 1.0 mm. In the case of a single-layer body containing Ag or Cu, the thickness of each fusible conductor sheet 50a to 50f is preferably at least 0.01 mm but not more than 0.1 mm, and in the case of a laminate containing a low-melting point metal layer and a high-melting point metal layer, the thickness of each fusible conductor sheet 50a to 50f is preferably at least 0.1 mm but not more than 0.5 mm.

Each of the first insulating members 61a to 61e and each of the second insulating members 62a and 62b is composed of a first insulating fragment 63a and a second insulating fragment 63b which face each other across a gap 65. Each of the first insulating fragments 63a and second insulating fragments 63b has guide pin through holes 64 into which guide pins 41 are inserted. The gap 65 is in a position corresponding with the central section 53 between the first end section 51 and the second end section 52 of each of the fusible conductor sheets 50a to 50f. In other words, each of the first insulating members 61a to 61e and each of the second insulating members 62a and 62b is partitioned at a position opposing the central section 53 between the first end section 51 and the second end section 52 of each of the fusible conductor sheets 50a to 50f.

The first insulating members 61a to 61e and the second insulating members 62a and 62b are preferably formed from a material having a tracking resistance index CTI of 500 V or higher.

A resin material may be used as the material for the first insulating members 61a to 61e and the second insulating members 62a and 62b. Examples of the resin material include the same materials as those described above for the cover 20 and the holding member 30.

Insulation wiring such as resin wiring or glass wiring may be used for the guide pins 41. Examples of materials that may be used for the resin wiring include polyamide-based resins, polyethylene resins, polypropylene resins and polycarbonate resins. The diameter of the guide pins 41 may be, for example, within a range from at least 0.5 mm but not more than 1.2 mm. The guide pins 41 may be, for example, formed from nylon wire.

The fuse element laminated body 40 can be produced, for example, in the manner described below. First, the guide pins 41 are inserted in the guide pin insertion holes 38 of the first holding member 30a. Next, the guide pin through holes 64 of each of the first insulating members 61a to 61e and the second insulating members 62a and 62b are inserted over the guide pins 41, while the fusible conductor sheets 50a to 50f and the first insulating members 61a to 61e are stacked alternately in the thickness direction on top of the second insulating member 62a, and the second insulating member 62b is then placed on top of the uppermost fusible conductor sheet 50f, thus obtaining a laminated body. Instead of using the first holding member 30a with the inserted guide pins 41, a metal jig of a similar shape or having guide pins 41 that project upward in the appropriate locations may also be used.

### First Pressing Member, Second Pressing Member

One end of the first pressing member 71 is inserted in the pressing member insertion hole 39 of the first holding member 30a, and the other end of the first pressing member 71 makes contact with the end section of the second insulating fragment 63b of the second insulating member 62a on the side of the gap 65. The first pressing member 71 applies upward pressure (in the direction of the fusible conductor sheet 50a) to the second insulating fragment 63b. The pressure applied by the first pressing member 71 is, for example, a pressure which is insufficient to sever the fusible conductor sheets 50a to 50f, but which when the fusible conductor sheets 50a to 50f melt, is capable of pushing the second insulating fragments 63b of the first insulating members 61a to 61e and the second insulating members 62a and 62b in an upward direction.

One end of the second pressing member 72 is inserted in the pressing member insertion hole 39 of the second holding member 30b, and the other end of the second pressing member 72 makes contact with the end section of the first insulating fragment 63a of the second insulating member 62b on the side of the gap 65. The second pressing member 72 applies downward pressure (in the direction of the fusible conductor sheet 50f) to the first insulating fragment 63a. The pressure applied by the second pressing member 72 is, for example, a pressure which is insufficient to sever the fusible conductor sheets 50a to 50f, but which when the fusible conductor sheets 50a to 50f melt, is capable of pushing the first insulating fragments 63a of the first insulating members 61a to 61e and the second insulating members 62a and 62b in a downward direction.

A compressed coil spring or a rubber may be used, for example, as the first pressing member 71 and the second pressing member 72.

### First Terminal, Second Terminal

One end of the first terminal 91 is connected to the first end sections 51 of the fusible conductor sheets 50a to 50f, and the other end of the first terminal 91 is exposed outside the insulating case 10. Further, one end of the second terminal 92 is connected to the second end sections 52 of the fusible conductor sheets 50a to 50f, and the other end of the second terminal 92 is exposed outside the insulating case 10.

The first terminal 91 and the second terminal 92 may have substantially the same shape, or may have different shapes. Although there are no particular limitations on the thickness of the first terminal 91 and the second terminal 92, the thickness may be, for example, within a range from at least 0.3 mm to not more than 1.0 mm. The thickness values for the first terminal 91 and the second terminal 92 may be the same or different.

The first terminal 91 has an external terminal hole 91a. Further, the second terminal 92 has an external terminal hole 92a. One of either the external terminal hole 91a or the external terminal hole 92a is used for connection to a power source, and the other is used for connection to a load. Alternatively, the external terminal hole 91a and the external terminal hole 92a may be used for connection within the current path inside the load. The external terminal hole 91a and the external terminal hole 92a may be formed as through holes having a substantially circular shape when viewed in plan view.

Terminals formed, for example, from copper, brass, or nickel or the like can be used as the first terminal 91 and the second terminal 92. From the viewpoint of strengthening the level of durability, brass is preferably used as the material for the first terminal 91 and the second terminal 92, whereas from the viewpoint of reducing electrical resistance, the use of copper is preferred. The first terminal 91 and the second terminal 92 may be formed from the same material, or may be formed from different materials.

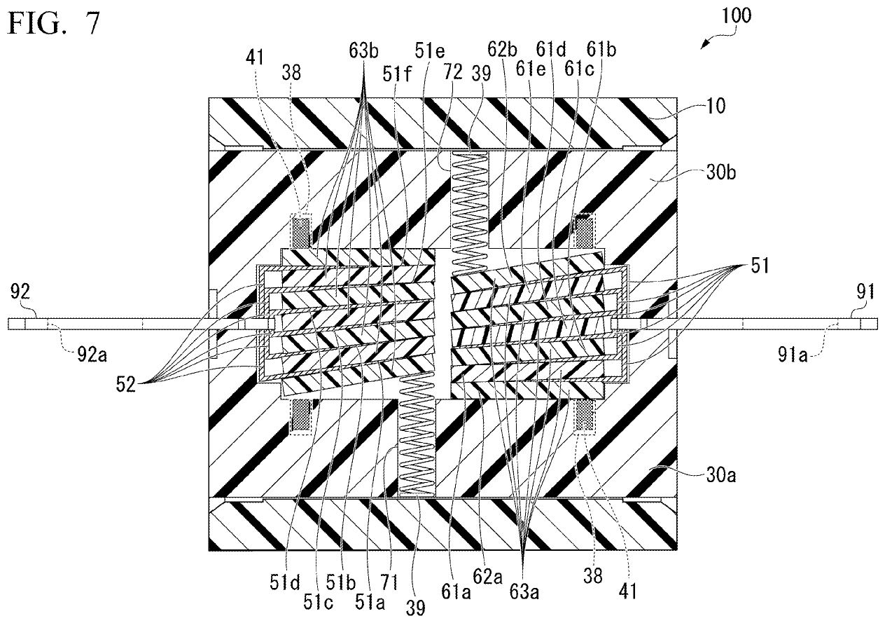

FIG. 7 is a longitudinal sectional view illustrating the fuse element laminated body 40 of the protective element 100 in a fused state. The longitudinal sectional view of FIG. 7 corresponds with a longitudinal sectional view along the line VI-VI′ shown in FIG. 1.

In FIG. 7, the central sections of the fusible conductor sheets 50a to 50f of the fuse element laminated body 40 have fused. As a result of the melting of the central sections of the fusible conductor sheets 50a to 50f, the pressure from the first pressing member 71 forces the second insulating fragments 63b of the first insulating members 61a to 61e and the second insulating members 62a and 62b upward. Further, the pressure from the second pressing member 72 forces the first insulating fragments 63a of the first insulating members 61a to 61e and the second insulating members 62a and 62bdownward. As a result, the laminated first insulating fragments and laminated second insulating fragments are forced close together and make contact, the space provided for the current path is physically blocked, and any arc discharge generated as a result of the melting of the fusible conductor sheets 50a to 50f can be rapidly extinguished.

### Method for Producing Protective Element

The protective element 100 of the embodiment described above can be produced in the manner described below.

First, the fuse element laminated body 40 positioned on either the first holding member 30a and the guide pins 41 or on a jig of a similar shape, and the first terminal 91 and second terminal 92 are prepared. Next, the first end sections 51 of the fusible conductor sheets 50a to 50f of the fuse element laminated body 40 are connected to the first terminal 91 by soldering. Similarly, the second end sections 52 are connected to the second terminal 92 by soldering. Conventional materials may be used as the solder material used in the soldering steps. From the viewpoints of the resistivity, the melting point and the desirability of using a lead-free material from an environmental perspective, the use of a solder containing Sn as the main component is preferred. The connection between the first end sections 51 of the fusible conductor sheets 50a to 50f and the first terminal 91, and the connections between the second end sections 52 of the fusible conductor sheets 50a to 50f and the second terminal 92 are not limited to solder connections, and other conventional bonding methods such as welding or the like may also be used.

Subsequently, the first holding member 30a and the second holding member 30b are prepared. The fuse element laminated body 40 with the connected first terminal 91 and second terminal 92 is placed inside the fuse element housing section 37 of the first holding member 30a. At this time, the guide pins 41 of the fuse element laminated body 40 are inserted into the guide pin insertion holes 38 of the first holding member 30a. Next, the second holding member 30b is placed on top of the first holding member 30a housing the fuse element laminated body 40 with the fuse element housing section 37 of the second holding member 30b facing the fuse element laminated body 40. At this time, the guide pins 41 of the fuse element laminated body 40 are inserted into the guide pin insertion holes 38 of the second holding member 30b, while the protrusions 35 of the first holding member 30a engage with the recesses 36 of the second holding member 30b, and the recesses 36 of the first holding member 30a engage with the protrusions 35 of the second holding member 30b. This completes the formation of the holding member 30.

Next, the first pressing member 71 and the second pressing member 72 are prepared. The first pressing member 71 is placed, in a compressed state, inside the pressing member insertion hole 39 of the first holding member 30a, and the second pressing member 72 is placed, in a compressed state, inside the pressing member insertion hole 39 of the second holding member 30b.

Next, the cover 20 is prepared. Then, the holding member 30 is inserted into the housing section 22 of the cover 20. Subsequently, an adhesive is injected into the terminal adhesive injection port 33 of the holding member 30, and the gap between the terminal mounting surface 32 and the first terminal 91 and the second terminal is closed. Further, the adhesive is also injected into the case adhesive injection port 34 and onto the inclined surface 21 of the cover 20, thereby bonding together the cover 20 and the holding member 30. For the adhesive, for example, an adhesive containing a thermosetting adhesive may be used. This completes formation of the insulating case 10 with the inside of the cover 20 in a sealed state.

The above steps yield the protective element 100 of and embodiment of the present invention.

In the protective element 100 of this embodiment, the fuse element laminated body 40 includes the plurality of fusible conductor sheets 50a to 50f arranged in parallel through the thickness direction, and those fusible conductor sheets 50a to 50f are insulated by being either in proximity to, or in contact with (adhered to), the interposed first insulating members 61a to 61e. Accordingly, the electric current value flowing through each of the fusible conductor sheets 50a to 50f is reduced and the space surrounding each of the fusible conductor sheets 50a to 50f is narrowed significantly, making it easier to reduce the scale of any arc discharge that occurs upon fusing. Consequently, by using the protective element 100 of this embodiment, the insulating case 10 can be reduced in both size and weight.

In the protective element 100 of this embodiment, by disposing the second insulating members 62a and 62b respectively between the lowermost located fusible conductor sheet 50a among the fusible conductor sheets 50a to 50f and the first holding member 30a of the insulating case 10, and between the uppermost located fusible conductor sheet 50f among the fusible conductor sheets 50a to 50f and the second holding member 30b of the insulating case 10, the fusible conductor sheets 50a and 50f do not make direct contact with the first holding member 30a and the second holding member 30b, and therefore it becomes less likely that arch discharge will cause the formation of carbides that can function as current paths on the internal surfaces of the insulating case 10, thereby a leakage current is unlikely to occur even if the size of the insulating case 10 is reduced.

In the protective element 100 of this embodiment, by partitioning the first insulating members 61a to 61e and the second insulating members 62a and 62b at positions opposing the central section 53 between the first end section 51 and the second end section 52 of the fusible conductor sheets 50a to 50f, when the fusible conductor sheets 50a to 50f melt within the central section 53, adhesion of continuous molten scattered pieces to the surfaces of the first insulating members 61a to 61e and the second insulating members 62a and 62b can be suppressed. As a result, any arc discharge generated as a result of the melting of the fusible conductor sheets 50a to 50f can be rapidly extinguished, and the insulating resistance of the protective element 100 following cutoff can be increased.

In the protective element 100 of this embodiment, by providing the first pressing member 71 and the second pressing member 72, when the fusible conductor sheets 50a to 50f melt, the fusible conductor sheets 50a to 50f are pressured and can move in both the upward and downward directions, and within the fusion portion (destroyed portion) on the first end section 51 side of the fusible conductor sheets 50a to 50f, the laminated first insulating fragments and laminated second insulating fragments are forced close together and make contact, and the space for the current path is physically blocked. Consequently, any arc discharge generated as a result of the melting of the fusible conductor sheets 50a to 50f can be even more rapidly extinguished. The protective element 100 of this embodiment has the first pressing member 71 and the second pressing member 72, but a structure provided with only one of the first pressing member 71 and the second pressing member 72 may also be used.

In the protective element 100 of this embodiment, by forming at least one component among the first insulating members 61a to 61e, the second insulating members 62a and 62b, and the cover 20 and holding member 30 of the insulating case 10 from a material having a tracking resistance index CTI of 500 V or higher, the formation of carbides that can function as a current path on the surfaces of these components as a result of arc discharge becomes less likely, and the leakage current becomes less likely to occur even when the size of the insulating case 10 is reduced.

In the protective element 100 of this embodiment, by forming at least one component among the first insulating members 61a to 61e, the second insulating members 62a and 62b, and the cover 20 and holding member 30 of the insulating case 10 from a polyamide-based resin or a fluorine-based resin, the superior insulating properties and tracking resistance of the polyamide-based resin or fluorine-based resin make it easier to achieve a combination of reduced size and reduced weight.

In the protective element 100 of this embodiment, by constructing each of the fusible conductor sheets 50a to 50f as a laminate containing a low-melting point metal layer and a high-melting point metal layer, wherein the low-melting point metal layer contains Sn, and the high-melting point metal layer contains Ag or Cu, the melting of the low-melting point metal layer causes the high-melting point metal layer to dissolve in the Sn, and therefore the fusion temperature of the fusible conductor sheets 50a to 50f is lowered. Further, because Ag and Cu have higher physical strength than Sn, the physical strength of fusible conductor sheets 50a to 50f composed of a laminate of a low-melting point metal layer and a high-melting point metal layer is higher than the physical strength of a layer composed solely of a low-melting point metal. Moreover, Ag and Cu have lower electrical resistivity than Sn, and the electrical resistance value of fusible conductor sheets 50a to 50f composed of a laminate of a low-melting point metal layer and a high-melting point metal layer is lower than the electrical resistance value of a layer composed solely of a low-melting point metal. In other words, a fuse element compatible with a larger electric current can be obtained.

In the protective element 100 of this embodiment, by forming each of the fusible conductor sheets 50a to 50f as a laminate having two or more high-melting point metal layers and one or more low-melting point metal layers, with each low-melting point metal layer disposed between a pair of high-melting point metal layers, high-melting point metal layers are disposed at the outside surfaces, and therefore the strength of the fusible conductor sheets 50a to 50f increases. Particularly in those cases where the first end sections 51 of the fusible conductor sheets 50a to 50f and the first terminal 91, and the second end sections 52 and the second terminal 92 are connected by soldering, deformation of the fusible conductor sheets 50a to 50f due to the heat applied during soldering becomes less likely.

In the protective element 100 of this embodiment, by constructing each of the fusible conductor sheets 50a to 50f as a single layer containing either silver or copper, the electrical resistivity can be more easily reduced compared with the case of a laminate of a high-melting point metal layer and a low-melting point metal layer. Accordingly, even in those cases where fusible conductor sheets 50a to 50f composed of a single layer containing silver or copper have a similar electrical resistance for the same surface area as fusible conductor sheets 50a to 50f composed of a laminate of a high-melting point metal layer and a low-melting point metal layer, the thickness of the sheets can be reduced. By reducing the thickness of the fusible conductor sheets 50a to 50f, the amount of molten scatted material generated when the fusible conductor sheets 50a to 50f fuse also decreases proportionally, and the insulating resistance following cutoff can be increased.

In the protective element 100 of this embodiment, each of the fusible conductor sheets 50a to 50f are provided with the through hole 54 in the central section 53, and have a fusion portion in which the cross-sectional area of the central section 53 across the direction of current flow is smaller than the cross-sectional area of the first end section 51 and the second end section 52 across the direction of current flow, and as a result, the site where fusion occurs when an electric current exceeding the rated value flows through the current path is stable. In the protective element 100 of this embodiment, the through hole 54 was provided in the central section 53, but there are no particular limitations on the method used for reducing the cross-sectional area of the central section 53. For example, the cross-sectional area of the central section 53 may also be reduced by cutting notches into both ends of the central section 53.

The protective element of the present invention is not limited to the embodiment described above.

For example, in the protective element 100 of the embodiment described above, the insulating case 10 is a circular cylindrical shape, but there are no particular limitations on the shape of the insulating case 10. The insulating case 10 may be a cubic shape. Further, the fuse element laminated body 40 has a structure containing six laminated fusible conductor sheets 50a to 50f, but there are no particular limitations on the number of fusible conductor sheets. The number of fusible conductor sheets may be any number of two or more. The number of fusible conductor sheets may be, for example, within a range from at least two to not more than 10.

### DESCRIPTION OF THE REFERENCE SIGNS

10: Insulating case
20: Cover
21: Inclined surface
22: Housing section
30: Holding member
30a: First holding member
30b: Second holding member
31a: First end section
31b: Second end section
32: Terminal mounting surface
33: Terminal adhesive injection port
34: Case adhesive injection port
34a: Slot
35: Protrusion
36: Recess
37: Fuse element housing section
38: Guide pin insertion hole
39: Pressing member insertion hole
40: Fuse element laminated body
41: Guide pin
50a, 50b, 50c, 50d, 50e, 50f: Fusible conductor sheet
51: First end section
52: Second end section
53: Central section
54: Through hole
61a, 61b, 61c, 61d, 61e: First insulating member
62a, 62b: Second insulating member
63a: First insulating fragment
63b: Second insulating fragment
64: Guide pin through hole
65: Gap
71: First pressing member
72: Second pressing member
80: Internal pressure buffering space
91: First terminal
92: Second terminal
91a, 92a: External terminal hole
100: Protective element

1. A protective element comprising:
a fuse element laminated body;
an insulating case housing the fuse element laminated body;
a first terminal; and
a second terminal, wherein
the fuse element laminated body includes a plurality of fusible conductor sheets arranged in parallel in a thickness direction, and a first insulating member disposed between each of the plurality of fusible conductor sheets, either in proximity to, or in contact with, the fusible conductor sheets,
each of the plurality of fusible conductor sheets has a mutually opposing first end section and second end section,
one end of the first terminal is connected to the first end section while another end of the first terminal is exposed outside the insulating case, and
one end of the second terminal is connected to the second end section while another end of the second terminal is exposed outside the insulating case.

2. The protective element according to claim 1, wherein a second insulating member is disposed between a lowermost located fusible conductor sheet among the plurality of fusible conductor sheets and the insulating case, and between an uppermost located fusible conductor sheet among the plurality of fusible conductor sheets and the insulating case.

3. The protective element according to claim 2, wherein the first insulating member and the second insulating member are partitioned in a central section between the first end section and the second end section of the fusible conductor sheets so as to cut the first insulating member and the second insulating member along a direction from the first end section toward the second end section.

4. The protective element according to claim 2, further comprising:
a pressing member which is disposed inside the insulating case and applies pressure to the second insulating member in a direction of a side of the fusible conductor sheets.

5. The protective element according to claim 2, wherein at least one of the first insulating member, the second insulating member and the insulating case is formed from a material having a tracking resistance index CTI of 500 V or higher.

6. The protective element according to claim 2, wherein at least one of the first insulating member, the second insulating member and the insulating case is formed from a resin material selected from the group consisting of polyamide-based resins and fluorine-based resins.

7. The protective element according to claim 1, wherein each of the plurality of fusible conductor sheets is a laminate having a low-melting point metal layer and a high-melting point metal layer, the low-melting point metal layer contains tin, and the high-melting point metal layer contains silver or copper.

8. The protective element according to claim 7, wherein each of the plurality of fusible conductor sheets is a laminate having two or more of the high-melting point metal layer and one or more of the low-melting point metal layer, and
each low-melting point metal layer is disposed between two high-melting point metal layers.

9. The protective element according to claim 1, wherein each of the plurality of fusible conductor sheets is a single-layer body containing silver or copper.

10. The protective element according to claim 1, wherein each of the plurality of fusible conductor sheets has a fusion portion between the first end section and the second end section, and
a cross-sectional area of the fusion portion across a direction of current flow from the first end section toward the second end section is smaller than a cross-sectional area of the first end section and the second end section across the direction of current flow.

11. The protective element according to claim 3, further comprising:
a pressing member which is disposed inside the insulating case and applies pressure to the second insulating member in a direction of a side of the fusible conductor sheets.

12. The protective element according to claim 3, wherein at least one of the first insulating member, the second insulating member and the insulating case is formed from a material having a tracking resistance index CTI of 500 V or higher.

13. The protective clement according to claim 3, wherein at least one of the first insulating member, the second insulating member and the insulating case is formed from a resin material selected from the group consisting of polyamide-based resins and fluorine-based resins.
